(19) United States
(12) Patent Application Publication
(10) Pub. No.: US 2008/0200729 A1
(43) Pub. Date: Aug. 21, 2008

(54) Preparation of Aryl Phosphines

(76) Inventors: Gordon Finlay Docherty, Kings Heath (GB); Graham MacArthur Good, Dudley (GB); Lucie Malosse, Tours (FR)

Correspondence Address: Jean-Louis Seugnet;Rhodia Inc., 8 Cedar Brook Drive, Cranbury, NJ, 08512-7500, US

(21) Appl. No.: 10/568,854

(22) PCT Filed: Sep. 3, 2004
(86) PCT No.: PCT/GB04/03815

§ 371 Date: Oct. 6, 2006

(30) Foreign Application Priority Data
Sep. 5, 2003 (GB) 0320796.6

(51) Int. Cl. C07F 9/50

(52) U.S. Cl. 568/17

(57) ABSTRACT

A method of making an aryl phosphine is provided. The method comprises reacting an organophosphine of general formula (1): HPXY with a substituted aryl compound in the presence of a catalyst, a base, a ligand and an iodine containing co-catalyst. In formula (1) X and Y can be the same or different and are cycloalkyl; substituted alkyl; primary, secondary and tertiary alkyl; and heterocyclic moieties; and one of X and Y can optionally be hydrogen.

This invention relates to a method of manufacturing aryl phosphines and to aryl phosphines manufactured by way of such a method.

Aryl phosphines are very important for many reactions catalysed by transition metals.

Hitherto it has been known to synthesise aryl phosphines using copper catalysed cross-coupling reactions. These reactions are typically carried out in the presence of a copper catalyst, a solvent, a base and a ligand.

However, the above known methods have a major disadvantage. In particular, the reaction is dependent on the electronic and steric properties of the phosphines used. The prior art clearly states that aryl bromide compounds fail to couple with dialkyl phosphines even in the presence of a ligand. For this reason the above method is limited to coupling such aryl bromides with diaryl phosphines.

The applicants have now found that the addition of an iodine containing co-catalyst to the reaction enables dialkyl phosphines to be coupled to substituted aryl compounds, especially aryl halides.

Accordingly, the present invention provides a method of making an aryl (as herein defined) phosphine, which method comprises the steps of:

reacting an organophosphine of general formula (1)

HPXY (1)

wherein:
X and Y can be the same or different and are selected from the group consisting of cycloalkyl; substituted alkyl; primary, secondary and tertiary alkyl; and heterocyclic moieties; and one of X and Y can optionally be hydrogen; with a substituted aryl (as herein defined) compound, in the presence of a catalyst, a base, a ligand and an iodine containing co-catalyst.

“Aryl” in this application is to be construed as including mononuclear and polynuclear aryl groups as well as substituents thereof.

The aryl group may be selected from benzene, toluene, xylene, biphenyl, fluorene, naphthalene, anthracene, phenanthrene, pyrene, benzo-pyrene, chrysene, coronene, indene and ferrocene. It may further selected from heteroaromatic groups such as furan, pyridine, pyrrole and thiophene, as well as substituents thereof.

The substituted aryl compound may be an aryl halide or, for example, an aryl toluene sulphonate, aryl methane sulphonate, aryl trifluoromethane sulphonate, aryl carboxylate or an aryl ester.

The iodine containing co-catalyst is preferably ionic.

The ionic, iodine containing co-catalyst is preferably selected from the group consisting of sodium iodide, potassium iodide and tetrabutyl ammonium iodide.

The solvent is preferably an aromatic hydrocarbon (such as toluene or xylene) or an ether (such as tetrahydrofuran or dioxane).

The catalyst is preferably selected from the group consisting of copper iodide, copper bromide and copper chloride.

The base is preferably selected from the group consisting potassium carbonate, potassium phosphate, cesium carbonate, sodium methoxide, sodium tertiary butoxide, sodium acetate and potassium tertiary butoxide.

The ligand is preferably N,N′ dimethylethylene diamine (DMEDA).

The reaction is suitably carried out at a temperature of between 90° C. and 130° C. Preferably the reaction is carried out at about 110° C.

The present invention will now be described with reference to the accompanying example

### Preparation of 1-Naphthalenyldicyclohexylphosphine

TABLE A

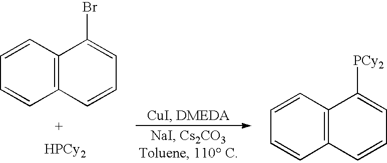

| | Mass | Volume |
|---|---|---|
| Substances | (g) | (mL) |
| Copper Iodide | 0.4 | |
| Anhydrous toluene | | 75 |
| Di-cyclohexyl phosphine | 4.24 | |
| N,N′- | 1.35 | |
| Dimethylethylenediamine | | |
| (DMEDA) | | |
| 1-Bromonaphthalene | 5.00 | |
| Cesium carbonate | 23.7 | |
| Sodium iodide | 5.81 | |

Cy = Cyclohexyl

An oven dried Schlenk tube was evacuated and refilled with nitrogen three times, then charged with copper iodide (0.2 g) followed by anhydrous toluene (50 ml), dicyclohexylphosphine (4.24 g) and DMEDA (0.65 g). The solution was stirred for 10 min.

1-Bromonaphthalene (5 g) and cesium carbonate (15.7 g) were added at once followed by anhydrous toluene (25 ml). The reaction mixture was stirred at 110° C. for 19 h, then cooled to room temperature. A sample (i) of the brown solution was taken for NMR analysis (See Table B). Further samples were taken at regular intervals and the results are shown in Table B.

(ii) The reaction mixture was stirred at 110° C. for a further 21 h, then cooled to room temperature and sampled for NMR analysis.

(iii) CuI (0.2 g), DMEDA (0.7 g) and CS₂CO₃ (8 g) were added to the Schlenk tube. The reaction was stirred at 110° C. for a further 21 h and sampled for NMR analysis.

(iv) The reaction was stirred at 120° C. for a further 10 h and sampled for NMR analysis.

(v) NaI (5.8 g) was added to the Schlenk tube. The reaction was stirred at 120° C. for 16 h and sampled for NMR analysis.

(vi) The reaction was stirred at 120° C. for a further 17 h and sampled for NMR analysis.

(vii) The reaction was stirred at 120° C. for a further 21 h and sampled for NMR analysis.

(viii) The reaction was stirred at 120° C. for a further 3 h and sampled for NMR analysis.

TABLE B

| | | % Conversion |
|---|---|---|
| | | of HPCy₂ to |
| Sample | Time Point (Hrs) | ArPCy₂ |
| (i) | 19 | 0 |
| (ii) | 40 | 0 |
| (iii) | 61 | 0 |
| (iv) | 71 | 2.6 |
| (v) | 87 | 12.6 |
| (vi) | 104 | 33.2 |
| (vii) | 125 | 63.5 |
| (viii) | 128 | 74.3 |

1-17. (canceled)

18. A method of making an aryl phosphine comprising the steps of: reacting an organophosphine of general formula (I):
HPXY
wherein:
X and Y are the same or different and are selected from the group consisting of cycloalkyl; substituted alkyl; primary, secondary and tertiary alkyl; and heterocyclic moieties; one of X and Y being optionally hydrogen;
with a substituted aryl compound, in the presence of a catalyst, a base, a ligand and an iodine containing co-catalyst.

19. The method as claimed in claim 18 wherein the aryl group is benzene, toluene, xylene, biphenyl, fluorene, naphthalene, anthracene, phenanthrene, pyrene, benzo-pyrene, chrysene, coronene, indene or ferrocene.

20. The method as claimed in claim 18 wherein the aryl group is furan, pyridine, pyrrole, or thiophene.

21. The method as claimed in claim 18 wherein the substituted aryl compound is an aryl halide.

22. The method as claimed in claim 18 wherein the substituted aryl compound is selected from the group consisting of aryl toluene sulphonates, aryl methane sulphonates, aryl trifluoromethane sulphonates, aryl carboxylates and aryl esters.

23. The method as claimed in claim 18 wherein the iodine containing co-catalyst is ionic.

24. The method as claimed in claim 23 wherein the ionic iodine containing co-catalyst is selected from the group consisting of sodium iodide, potassium iodide and tetrabutyl ammonium iodide.

25. The method as claimed in claim 18 wherein the solvent is an aromatic hydrocarbon.

26. The method as claimed in claim 25 wherein the solvent is toluene or xylene.

27. The method as claimed in claim 18 wherein the solvent is an ether.

28. The method as claimed in claim 27 wherein the solvent is tetrahydrofuran or dioxane.

29. The method as claimed in claim 18 wherein the catalyst is selected from the group consisting of copper iodide, copper bromide and copper chloride.

30. The method as claimed in claim 18 wherein the base is selected from the group consisting of potassium carbonate, potassium phosphate, cesium carbonate, sodium methoxide, sodium tertiary butoxide, sodium acetate and potassium tertiary butoxide.

31. The method as claimed in claim 18 wherein the ligand is N,N′-dimethylethylene diamene (DMEDA).

32. The method as claimed in claim 18 wherein the reaction is carried out at a temperature of between 90° C. and 130° C.

33. The method as claimed in claim 32 wherein the reaction is carried out at 110° C.
